(19) United States
(12) Patent Application Publication
(10) Pub. No.: US 2025/0035537 A1
(43) Pub. Date: Jan. 30, 2025

(54) Coupon Sampler, System and Methods of Use Thereof

(71) Applicants: ABILENE CHRISTIAN UNIVERSITY, Abilene, TX (US); GEORGIA TECH RESEARCH CORPORATION, Atlanta, GA (US)

(72) Inventors: Tim Head, Abilene, TX (US); Jonathan Scherr, Abilene, TX (US); Jack Shoemate, Abilene, TX (US); Trevor Ruhl, Atlanta, GA (US); Steven Biegalski, Atlanta, GA (US); Preet Singh, Atlanta, GA (US)

(21) Appl. No.: 18/778,349

(22) Filed: Jul. 19, 2024

Related U.S. Application Data
(60) Provisional application No. 63/515,235, filed on Jul. 24, 2023.

(51) Int. Cl. G01N 17/04; G01N 1/20; G21C 3/18; G21C 3/54; G21C 17/017

(52) U.S. Cl. CPC G01N 17/046; G01N 1/2035; G21C 3/18; G21C 3/54; G21C 17/017; G01N 2001/205

(57) ABSTRACT

A coupon sampler for a reactor system includes a lower assembly having an in-line portion configured to receive a flow of a molten salt, and a lower assembly pipe portion extending transverse from the in-line portion and defining a lower channel therethrough. The coupon sampler further includes an upper assembly fluidically coupled with the lower assembly. The upper assembly includes an upper assembly pipe portion defining an upper channel therethrough and cooperating with the lower channel to define a sampling channel of the coupon sampler. The coupon sampler further includes a coupon device disposed fully within the sampling channel. The coupon sampler further includes an actuation mechanism operatively coupled with the coupon device and configured to move the coupon device axially into and out of the flow of the molten salt.

### RELATED APPLICATIONS

The present application relates and claims priority to U.S. Provisional Application No. 63/515,235, filed on Jul. 24, 2023, which is hereby incorporated by reference in its entirety.

### TECHNICAL FIELD

The described examples relate generally to systems, devices, and techniques for a corrosivity sampling device.

### BACKGROUND

Corrosivity sampling is used in numerous systems, such as nuclear systems, to monitor the amount of corrosion occurring to the structural components in contact with a given solution. As one example, molten salt reactors (MSRs) offer an approach to nuclear power that utilizes molten salts as their nuclear fuel in place of the conventional solid fuels used in light water reactors. Changes in the properties of the molten salt or liquid can have drastic effects on pipe walls or various other wetted equipment of the system. By taking a coupon test, an analysis of the corrosion rate can be performed to certify the system and indicate a useful remaining life of pipe walls and other components.

Corrosion monitoring in such MSRs may be conducted using a coupon of material that is arranged at least partially in the molten salt. After a defined period of time, the coupon may be removed from the molten salt in order to analyze the extent of corrosion on the coupon. The extension of corrosion on the coupon may be indicative of the corrosion occurring on other similarly situation components of the MSR, such as pipes and the like having the same or similar material composition as the coupon. In many cases, coupon extraction may be burdensome and impractical, particularly in the context of an MSR system, which may not be readily taken off-line. Further, conventional designs may hinder the ability to arrange a material coupon in to, and out of, direct operational flow, thus reducing the ability of the coupon to experience homogenous flow. Conventional designs may further limit the ability to maintain the coupon in an inert environment after sampling, thereby reducing the validity of the testing of the coupon. As such, there is a need for systems and techniques to facilitate the installation and removal of a coupon, and maintenance of the coupon in an inert environment.

### SUMMARY

In one example a coupon sampler for a reactor system is disclosed. The coupon sampler includes a lower assembly having an in-line portion configured to receive a flow of a molten salt. The lower assembly further includes a lower assembly pipe portion extending transverse from the in-line portion and defining a lower channel therethrough. The coupon sampler further includes an upper assembly fluidically coupled with the lower assembly. The upper assembly further includes an upper assembly pipe portion defining an upper channel therethrough and cooperating with the lower channel to define a sampling channel of the coupon sampler. The coupon sampler further includes a coupon device (e.g., such as a monolithic piece of stainless steel material, as described herein) disposed fully within the sampling channel. The coupon sampler further includes an actuation mechanism operatively coupled with the coupon device and configured to move the coupon device axially into and out of the flow of the molten salt.

In another example, the coupon system may include an inert gas system configured to maintain an inert environment in the sampling channel.

In another example, the lower assembly may include a first isolation valve integrated with the lower assembly pipe portion that is configured to block flow through the lower channel. Further, the upper assembly may include a second isolation valve integrated with the upper assembly pipe portion that is configured to block flow through the upper channel.

In another example, the actuation mechanism may be configured to move the coupon device between: (i) an isolation position in which the coupon device is disposed fully within the upper channel, and (ii) a sampling position in which the coupon device is disposed at least partially in both the lower channel and the flow of molten salt.

In another example, in the isolation position, each of the first isolation valve and the second isolation valve may be closeable to block flow through the respective upper channel and lower channel and to fluidically isolate the coupon device from the flow of molten salt. Further, in the sampling position, each of the first isolation valve and the second isolation valve may remain open and allow at least a portion of the coupon device to be disposed therethrough.

In another example, in the isolation position, the upper assembly, having the coupon device disposed fully within, may be separable from the lower assembly. In this regard, the upper assembly may maintain the coupon device in an inert environment subsequent to separation of the upper assembly from the lower assembly.

In another example, the coupon sampler may further include a pair of flange caps. Each flange cap of the pair of flange caps may be coupled to an opposing end of the upper assembly pipe portion and establish a sealed barrier between the upper channel and an external environment.

In another example, each of the first isolation valve and the second isolation valve may be non-wetted valves.

In another example, each of the first isolation valve and the second isolation valve may be full-port ball valves.

In another example, the coupon device may be a one-piece structure.

In another example, the coupon device may include an elongated portion extending axially through the sampling channel. The coupon device may further include a coupon portion protruding from a bottom end of the elongated portion and configured for placement in the flow of the molten salt. The coupon device may further include an engagement feature protruding from a top end of the elongated portion opposite the bottom end that is configured for operable coupling with the actuation mechanism. The coupon device may further include a stop feature proximal the bottom end extending away from the elongated portion. The stop feature may be configured to define a maximum extent to which the coupon portion is placed in the flow of the molten salt.

In another example, the stop feature may include a conical structure extending about a circumference of the elongated portion of the coupon device. In this regard, the lower assembly may include a transition piece fluidically between the lower assembly pipe portion and the in-line portion. The transition piece may have an angled transition portion that is complementary in shape to the conical structure of the coupon device. In this regard, the actuation mechanism axially moves the coupon device along the sampling channel. Further, a mating of the conical structure and angled transition portion defines a lower boundary of the axial movement of the coupon device within the sampling channel.

In another example, a coupon sampler for a reactor system is disclosed. The coupon sampler includes a combined assembly defining a sampling channel therethrough. The sampling channel has an inert gas therein. The coupon sampler includes a pair of isolation valves integrated in series with the sampling channel. Each isolation valve of the pair of isolation valves are configured to block flow through the sampling channel. The sampler further includes a coupon portion disposed within the sampling channel and being axially moveable therein between: (i) a sampling position in which the coupon portion is disposed at least partially in a flow of molten salt, and (ii) an isolation position in which the coupon portion is disposed within the sampling channel fully encompassed by the inert gas and fluidically isolated from the molten salt by the closure of each of the pair of isolation valves.

In another example, the combined assembly may include a lower assembly defining a lower channel therethrough. The combined assembly may further include an upper assembly defining an upper channel therethrough. The upper channel and the lower channel may cooperate to define the sampling channel. The combined assembly may further include a sealing element defining a sealed barrier between the lower assembly and the upper assembly.

In another example, in the isolation position, the coupon portion may be disposed fully within the upper channel. In this regard, the upper channel may be separable from the lower assembly at the sealing element while maintaining the coupon portion in the inert environment of the upper channel.

In another example, the coupon portion may define a tip of a coupon device disposed fully within the sampling channel. The coupon device may be actuatable by an actuation mechanism between the sampling position and the isolation position.

In another example, the coupon sampler may further include the actuation mechanism. The actuation mechanism may be configured to actuate the coupon device using one or more of: (i) a magnetic coupling, (ii) a robotic coupler, (iii) a cable, or (iv) a pressure differential.

In another example, the coupon device may be a one-piece structure formed from a stainless steel material.

In another example, the coupon device may include a stop feature configured to limit an entry of the coupon portion into the flow of molten salt.

In another example, the stop feature may include a conical collar that extends from an elongated body of the coupon device by a distance that exceeds a diameter of a transition piece that is arranged fluidically between the sampling channel and the flow of molten salt.

In another example, a method of operating a coupon sampler for a reactor system is disclosed. The method includes associating an in-line portion of a lower assembly with a flow line of a molten salt system. The lower assembly includes a lower assembly pipe portion extending transverse from the in-line portion and defining a lower channel therethrough. The method further includes inserting a coupon device into an upper channel of an upper assembly. The method further includes operating an inert gas system to purge room air from the upper assembly with inert gas. The method further includes removably coupling the lower assembly and the upper assembly to one another such that the lower channel and the upper channel define a continuous sampling channel. The method further includes operating an actuation mechanism to move the coupon device from the upper channel to a sampling position in which a portion of the coupon device is disposed in the flow line of the molten salt system.

In another example, the method may further include, prior to the operating, opening a first isolation valve and a second isolation valve. The first isolation valve may be integrated with the upper channel and operable to block flow therethrough. The second isolation valve may be integrated with the lower channel and operable to block flow therethrough. In this regard, the operating may include moving at least a portion of the coupon device through each of the first isolation valve and the second isolation valves.

In another example, the method may further include maintaining a coupon portion of the coupon device in the flow line of the molten salt system and exposing the coupon portion to molten salt flowing therethrough.

In another example, the method may further include second operating the actuation mechanism to move the coupon device from the sampling position to the upper channel such that the coupon device is fully within an inert environment of the upper channel.

In another example, the method may further include closing the first isolation valve and the second isolation valve. The method may further include removably uncoupling the upper assembly from the lower assembly.

In another example, the method may further include disposing the upper assembly in an inert environment while maintaining the coupon device within the inert environment of the upper channel.

In addition to the example aspects described above, further aspects and examples will become apparent by reference to the drawings and by study of the following description.

### BRIEF DESCRIPTION OF THE DRAWINGS

FIG. 1 depicts an example molten salt reactor system.

FIG. 2A depicts a system including an example coupon sampler for use with the molten salt reactor system of FIG. 1.

FIG. 2B depicts a cutaway view of the coupon sampler of FIG. 2A.

FIG. 3 depicts an exploded view of the coupon sampler of FIG. 2A.

FIG. 4A depicts a side view of a coupon device of the coupon sampler of FIG. 2A.

FIG. 4B depicts a front view of the coupon device of FIG. 4A.

FIG. 4C depicts an isometric view of a top portion of the coupon device of FIG. 4A.

FIG. 5A depicts an upper assembly of the coupon sampler of FIG. 2A.

FIG. 5B depicts a cross-sectional view of the upper assembly of FIG. 5A, taken along line 5B-5B of FIG. 5A.

FIG. 6A depicts a lower assembly of the coupon sampler of FIG. 2A.

FIG. 6B depicts a cross-sectional view of the lower assembly of FIG. 6A, taken along line 6A-6A of FIG. 6A.

FIG. 7A depicts a cross-sectional view of the coupon sampler of FIG. 2A having the coupon device in an isolation position, taken along line 7A-7A of FIG. 2A.

FIG. 7B depicts a cross-sectional view of the coupon sampler of FIG. 2A having the coupon device in a sampling position, taken along line 7A-7A of FIG. 2A.

FIG. 8 depicts detail 8-8 of FIG. 7B.

FIG. 9 depicts detail 9-9 of FIG. 7B.

FIG. 10 depicts another example system in which the coupon sampler of FIG. 2A is associated with the a magnetic actuator assembly.

FIG. 11A depicts a cross-sectional view of the system of FIG. 10 in which the coupon device is arranged in an isolation position, taken along line 11A-11A of FIG. 10.

FIG. 11B depicts a cross-section view of the system of FIG. 10 in which the coupon device is arranged in a sampling position, taken along line 11A-11A of FIG. 10.

FIG. 12A depicts an example robotic actuator for use with the coupon sampler of FIG. 2A.

FIG. 12B depicts a cross-sectional view of another example system including the coupon sampler of FIG. 2A and the robotic actuator disposed therein.

FIG. 12C depicts detail 12C-12C of FIG. 12B.

FIG. 13 depicts a cross-sectional view of another example system including the coupon sampler of FIG. 2A and a cable mechanism disposed therein.

FIG. 14 depicts a cross-sectional view of another example system including the coupon sampler of FIG. 2A and a plunger mechanism disposed therein.

FIG. 15 depicts the upper assembly of FIG. 7A having the coupon device enclosed in an inert environment.

FIG. 16 depicts a flow diagram of an example method of operating a coupon sampler.

FIG. 17A depicts an example sampling array.

FIG. 17B depicts the example sampling array of FIG. 17A associated with a control system.

FIG. 18 depicts an example reactor system including the sampling array of FIG. 17A.

FIG. 19 depicts a top view of the example reactor system of FIG. 18.

FIG. 20 depicts an example salt sampling mechanism of the example sampling array of FIG. 17A.

FIG. 21 depicts a flow diagram of an example method of operating a reactor system.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates generally to a coupon sampler for a reactor system, such as a molten salt reactor system. A molten reactor system may broadly include any of a variety of molten salt reactors that are used to produce nuclear power in part by utilizing molten salts as a nuclear fuel in place of the conventional solid fuels used in light water reactors. In molten salt reactors, fission reactions occur within a molten salt composition housed within a reactor vessel. The molten salt may circulate through a molten salt including the reactor vessel, various pipe runs, valves, pumps, and other components, all of which may be susceptible to corrosion over time. Corrosivity sampling may therefore be used to monitor the amount of corrosion occurring to these and other structural components of the system that are in contact with the molten salt. Corrosion monitoring in such MSRs may be conducted using a coupon of material that is arranged at least partially in the molten salt. After a defined period of time, the coupon may be removed from the molten salt in order to analyze the extent of corrosion on the coupon. The extension of corrosion on the coupon may be indicative of the corrosion occurring on other similarly situation components of the MSR, such as pipes and the like having the same or similar material composition as the coupon. In many cases, coupon extraction may be burdensome and impractical, particularly in the context of an MSR system, which may not be readily taken off-line. Further, conventional techniques may limit the ability to move the coupon into and out of an operational flow of a molten salt and/or to maintain the coupon an inert environment post sampling.

To mitigate these and other challenges, the coupon sampler of the present disclosure may be arranged for rapid installation and removal with a molten salt system and in a manner that allows a material coupon to remain in an inert environment post sampling. The coupon sampler may generally use a material coupon or coupon device (e.g., a monolithic piece of stainless steel material, as described herein) that is arranged in an inert environment that is fluidically coupled to an operational flow of molten salt material. The coupon sampler may be configured to actuate the coupon device between an isolation position, in which the coupon device is in the inert environment outside of the flow of the molten salt material, and a sampling position, in which the coupon device is at least partially within the flow of the molten salt material. After a set time period, the coupon sampler may operate to remove the coupon device from the flow of molten material and back into the isolation position. The coupon device may further be operable to fluidically isolate or otherwise physically close off the coupon device from the flow of molten material such that the coupon device is fully encompassed in and sealed within an inert environment. The coupon sampler, having the coupon device sealed in such inert environment, may be physically, mechanically separable from the flow of molten material and transported to another location for analysis. For example, the coupon sampler may allow the coupon device to be transported to a glove box, cover, or other laboratory setting, in which the coupon device can be analyzed in an inert environment, thereby promoting the validity of the analysis.

To facilitate the foregoing, the coupon sampler may include a lower assembly and an upper assembly. The lower assembly may generally be any collection of pipe runs, valves, collars, transition pieces, instruments or the like that cooperate to allow for an introduction of the coupon device into the flow of molten salt material from the inert environment of the coupon sampler. The upper assembly may generally be any collection of pipe runs, valves, collars, transition pieces, instructions or the like that cooperate to allow for the retrieval of the coupon device into an inert environment from the flow of molten salt material and for sealing the coupon device therein for transport to another inert environment. For example, the lower assembly may include an in-line portion configured to receive a flow of a molten salt, and a lower assembly pipe portion extending transverse from the in-line portion and defining a lower channel therethrough. The upper assembly may be fluidically coupled with the lower assembly and have an upper assembly pipe portion defining an upper channel therethrough and cooperating with the lower channel to define a sampling channel of the coupon sampler. The coupon device may be disposed fully within the sampling channel. The coupon sampler may further include an actuation mechanism operatively coupled with the coupon device and configured to move the coupon device axially into and out of the flow of the molten salt.

Upon conclusion of a predefined sampling period, the coupon sampler may operate to remove the coupon device from the flow of molten salt and store the coupon device in an inert environment of the coupon sampler. For example, the coupon sampler may include at least a first isolation valve that is integrated with the lower assembly and configured to block flow through the lower channel. The coupon sampler may further include a second isolation valve that is integrated with the upper assembly and configured to block flow through the upper channel. In this regard, upon conclusion of the predefined sampling period, the actuation mechanism may raise the coupon device from the sampling position back to the isolation position, in which the coupon device is fully out of the molten material and encompassed by the inert environment of the upper channel. For example, the coupon device may be raised and passed through both the first and the second isolation valves. Subsequently, the first and second isolation valves may be closed so that the coupon device is fluidically and physically separated form the flow of molten material. The upper assembly, with the coupon device being held fully therein, may therefore be separated from the lower assembly and transported to another environment, such as an environment remote from the reactor, at which the coupon device can be removed and inspected in an inert environment. In other examples, other implementations of the coupon sampler are contemplated herein, as described in greater detail below.

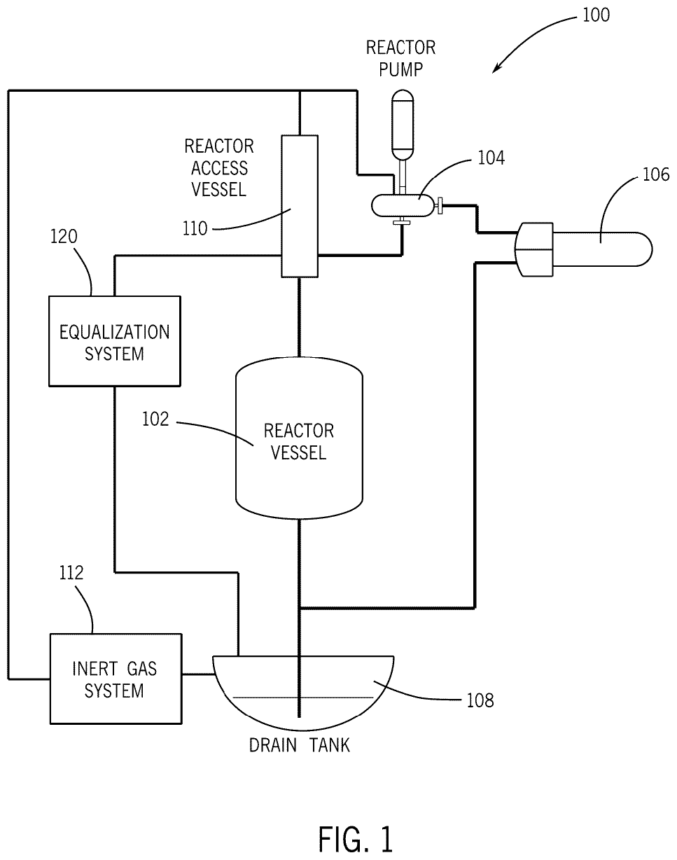

Turning to the drawings, for purposes of illustration, FIG. 1 depicts a schematic representation of an example molten salt reactor system 100. The molten salt reactor system 100 may implement and include the inert gas system and the equalization system, and implement any of the functionalities of each described herein. As will be understood and appreciated, the example shown in FIG. 1 represents merely one example configuration of a molten salt reactor system 100; it will be understood that other configurations of the molten salt reactor are possible and contemplated herein.

In various embodiments, a molten salt reactor system 100 utilizes fuel salt enriched with uranium (e.g., high-assay low-enriched uranium) to create thermal power via nuclear fission reactions. In at least one embodiment, the composition of the fuel salt may be LiF-BeF2-UF4, though other compositions of fuel salts may be utilized as fuel salts within the reactor system 100. The fuel salt within the system 100 is heated to high temperatures (about 700° C.) and melts as the system 100 is heated. In several embodiments, the molten salt reactor system 100 includes a reactor vessel 102 where the nuclear reactions occur within the molten fuel salt, a fuel salt pump 104 that pumps the molten fuel salt to a heat exchanger 106, such that the molten fuel salt re-enters the reactor vessel after flowing through the heat exchanger, and piping in between each component. The molten salt reactor system 100 may also include additional components, such as, but not limited to, drain tank 108 and reactor access vessel 110. The drain tank 108 may be configured to store the fuel salt once the fuel salt is in the reactor system 100 but in a subcritical state, and also acts as storage for the fuel salt if power is lost in the system 100. The reactor access vessel may be configured to allow for introduction of small pellets of uranium fluoride (UF4) to the system 100 as necessary to bring the reactor to a critical state and compensate for depletion of fissile material.

In several examples, the molten salt reactor system 100 may include an inert gas system 112 to provide inert gas to a head space of the drain tank 108, among other functions. The inert gas system 112 may further relieve inert gas from the head space of the drain tank 108 as needed. The inert gas system 112 is therefore operable to maintain pressurized inert gas in the head space of the drain tank 108 that is sufficient to substantially prevent the flow of molten fuel salt into the drain tank during normal operations. For example, with the head space of the drain tank 108 pressurized by the inert gas system 112, molten salt may generally circulate between the reactor vessel 102 and the heat exchanger 106 without substantially draining into the drain tank 108. As described herein, the inert gas system 112 may be configured to supply inert gas to the head space of various other components of the molten salt reactor system 100, such as to the head space of the reactor access vessel 110, to the seal of reactor pump 104, among other components. Upon the occurrence of a shutdown event, the inert gas system 112 may cease providing inert gas to the head space of the drain tank 108, and other components to which the system 112 supplies inert gas.

The molten salt reactor system 100 may further include an equalization system 120 that is operable to equalize the pressure between the head space of the drain tank 108 and the reactor vessel 102 upon the occurrence of a shutdown event. For example, during normal operation a pressure differential exists between the head space of the drain tank 108 and the reactor vessel 102. Such pressure differential prevents or impedes the draining of the fuel salt into the drain tank 108. In this regard, the equalization system 120 may be operable to fluidically couple (via opening one or more valves) the head space of the drain tank 108 and the reactor vessel 102 to reduce or eliminate the pressure differential, thereby allowing the fuel salt to readily flow into the drain tank upon the shutdown event. The equalization system 120 may include numerous redundances and/or bypasses in order to facilitate a fail-safe or walk-away safe operation with respect to depressurization of the system 100.

In several examples, the coupon sampler described herein may be used utilized to measure corrosion of the molten salt or other process fluid along a pipe that connects one or more of the vessels and/or other components of the molten salt reactor system 100. For example, the coupon sampler may be integrated with a run of pipe or segment between one or more of the reactor vessel 102, the reactor access vessel 110, the pump 104, the heat exchanger 106, and/or the drain tank 108. Additionally or alternatively, the coupon sampler may be integrated with a side run or by-pass pipe along the pipe of the main loop in order facilitate removal. Additionally or alternatively, the coupon sampler may be integrated with a vessel or component itself. For example, the coupon sampler may be integrated with, such as being attached to otherwise fluidically coupled with or installed with, one or more of the reactor vessel 102, the reactor access vessel 110, the pump 104, the heat exchanger 106, and/or the drain tank 108 and/or other component of the reactor system 100. In other examples, the coupon sampler may be integrated with other systems, subsystems, assemblies and the like of the molten salt or other system.

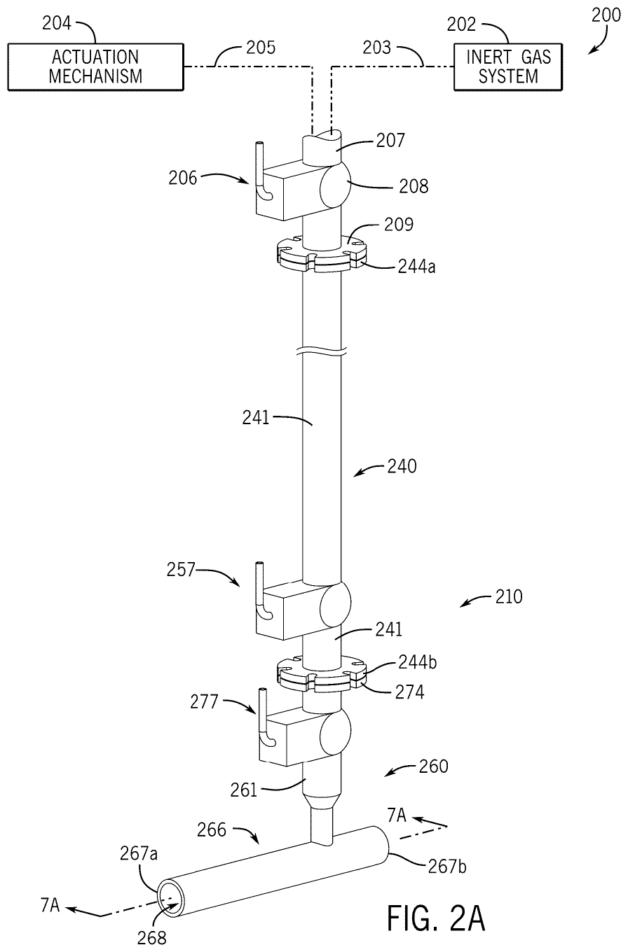

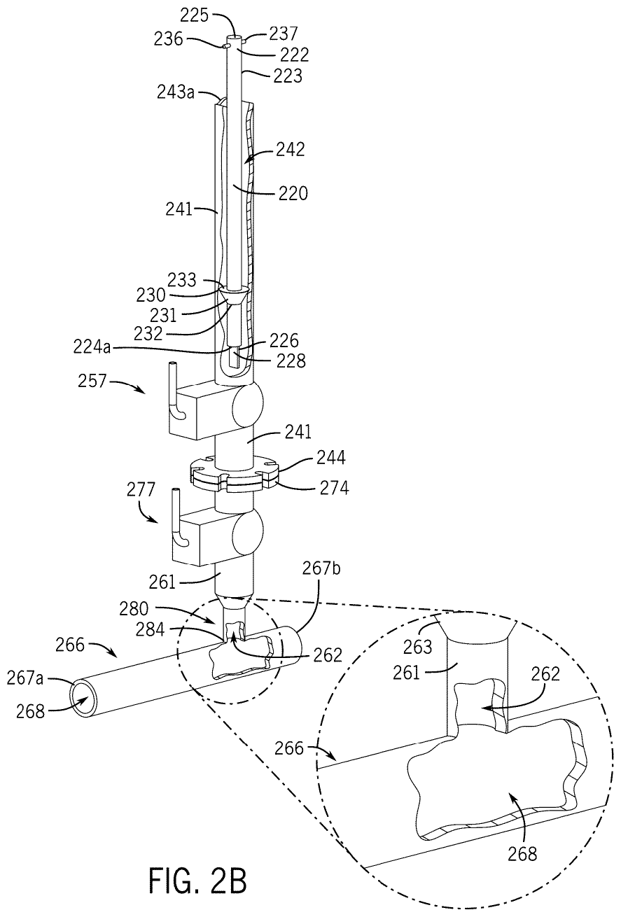

FIG. 2A depicts a system 200 including an example coupon sampler 210 for use with the molten salt reactor system of FIG. 1. The system 200 may generally include any of a variety of components and subassemblies that cooperate to allow for a material coupon to be moved into and out of a flow of a molten salt. The system 200 may further include any of a variety of components and subassemblies that cooperate to allow the material coupon to remain an inert environment prior to, during, and subsequent to the material coupon being arranged in the molten salt. To facilitate the foregoing, as shown in FIG. 2A, the system 200 may include an inert gas system 202, a linear actuation mechanism 204, a coupling assembly 206, and the coupon sampler 210. The coupon sampler 210, as will be described in greater detail below, may include a coupon device 220 (as shown in cutaway view of FIG. 2B), which includes a tip or paddle (e.g., a coupon portion 226) that defines the material coupon for which the coupon sampler 210 is configured to move into, and out of, the flow of molten salt. The coupon sampler 210 is configured to receive the coupon device 220, and contain the coupon device 220 within an interior sampling channel of the coupon sampler 210.

The coupon sampler 210 is shown in FIGS. 2A and 2B as including an upper assembly 240 and a lower assembly 260. The lower assembly 260 may generally be any collection of pipe runs, valves, collars, transition pieces, instruments or the like that cooperate to allow for an introduction of the coupon device 220 into the flow of molten salt material from the inert environment of the coupon sampler 210. The upper assembly 240 may generally be any collection of pipe runs, valves, collars, transition pieces, instructions or the like that cooperate to allow for the retrieval of the coupon device 220 into an inert environment from the flow of molten salt material and for sealing the coupon device 220 therein for transport to another inert environment. As described in greater detail herein, the coupon sampler 210 may be configured to move the coupon device 220 from an isolation position fully within the upper assembly 240, to a sampling position in which at least a portion of the coupon device 220 is disposed in a flow of a molten salt. The coupon sampler 210 may be further configured to move the coupon device 220 from such sampling position back to the isolation position.

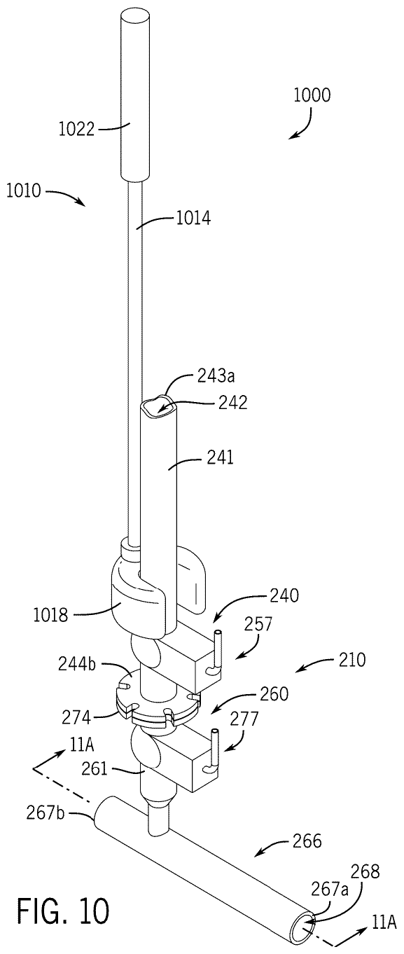

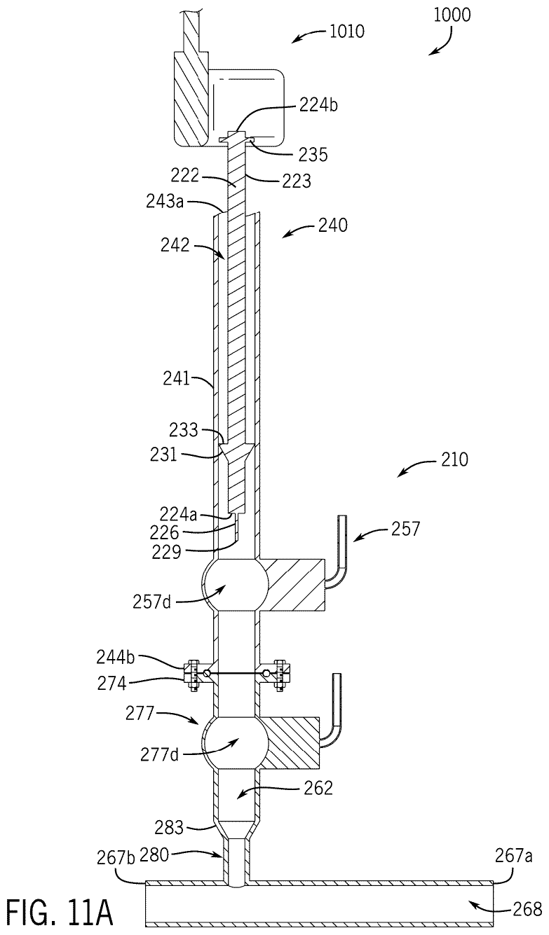

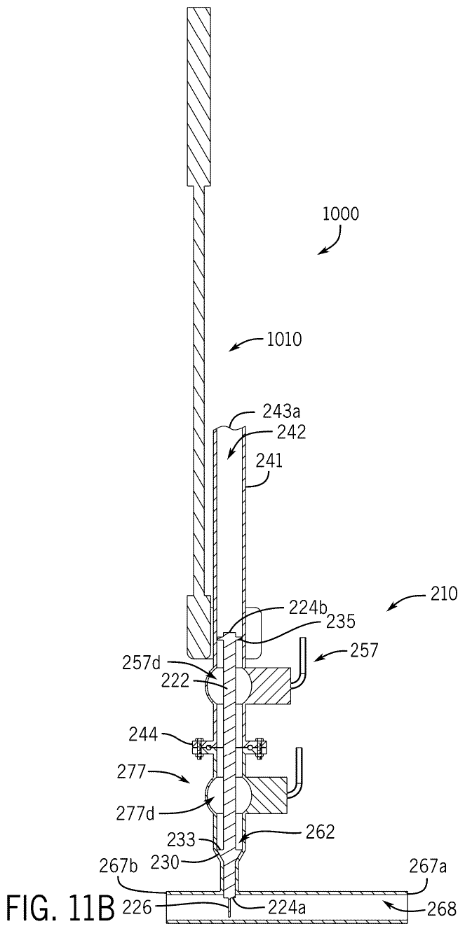

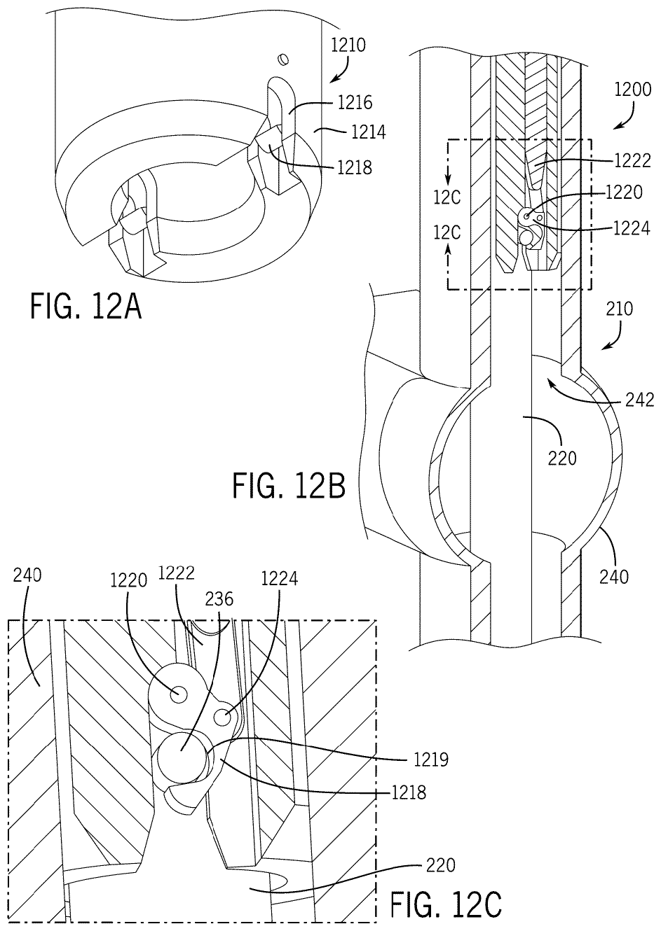

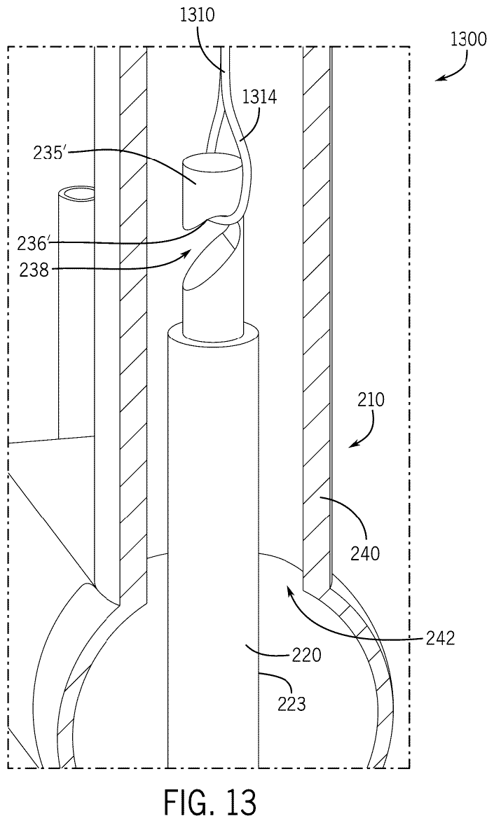

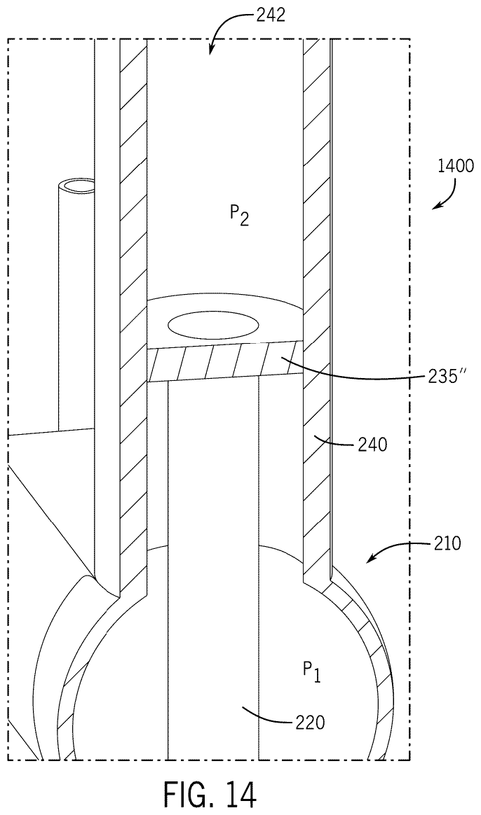

To facilitate the foregoing, the coupon sampler 210 may be operatively coupled with or include or otherwise be associated with the actuation mechanism 204. The actuation mechanism 204 may include a variety of components that are used to move, such as raising or lowering, the coupon device 220 within the coupon sampler 210. As described herein with reference to FIGS. 10-14, the actuation mechanism 204 may be configured to actuate the coupon device 220 via an operative connection 205 using one or more of a magnetic coupling, a robotic coupler, a cable, a pressure differential and/or other mechanism, including hand operation. For example, and as shown and described in relation to FIGS. 10-11B, the actuation mechanism 204 may include one or more magnetic drives that is configured to magnetically couple with a corresponding magnetic element of the coupon device 220 such that movement of the magnetic drive of the actuation mechanism 204 causes a corresponding movement of the coupon device 220 within the coupon sampler 210. In another example, and as shown and described in relation to FIGS. 12A-12C, the actuation mechanism 204 may include one or more robotic grabbers, such as one or more articulable linkages or other mechanical elements, that are configured to enter the coupon sampler 210 and physically engage a structure of the coupon device 220. In turn, the robotic grabber may be moved, such being moved up and down, in order to cause a corresponding movement of the coupon device 220 within the coupon sampler 210. In another example, and as shown and described in relation to FIG. 13, the actuation mechanism 204 may include one or more cables that are configured to enter the coupon sampler 210 and physically engage a structure of the coupon device 220. In turn, the cable may be moved, such as being moved up and down, in order to cause a corresponding movement of the coupon device 220 within the coupon sampler 210. In another example, and as shown and described in relation to FIG. 14, the actuation mechanism 204 may include one or more valves, seals, and insert gas lines that are configured to induce a pressure differential across the coupon device 220 within the coupon sampler 210. Such pressure differential may be operative to move the coupon device 220 therein. In other examples, other actuation mechanisms 204 are contemplated herein.

The coupon sampler 210 may be configured to maintain the coupon device 220 fully within an inert environment prior to, during, and subsequent to the placement of the coupon device 220 within the flow of molten salt. In this regard, the inert gas system 202 is shown in FIG. 2A as having an operative connection 203 for supply of an inert gas, such as a helium or other inert gas, to the coupon sampler 210. The inert gas system 202 may include any appropriate source of inert gas, such as a source of inert gas supplied from a gas vessel, bottle, or other source. The inert gas system 202 may be configured to continuous supply inert gas to the coupon sampler 210 such that the coupon device 220 (or a portion thereof) is continually encompassed by the inert gas. Further, the inert gas system 202 may be configured to continuously supply such inert gas at a pressure that is sufficiently elevated in order to maintain a positive pressure within an internal volume or channel of the coupon sampler 210. In some cases, the inert gas pressure may be maintained in the coupon sampler 210 at a sufficiently high pressure so that the inert gas supports backflow prevention or otherwise helps to mitigate the flow of the molten salt into the lower assembly 260 and/or the upper assembly 240.

In one implementation, the inert gas system 202 may deliver inert gas directly to the upper assembly 240 of the coupon sampler 210. In other examples, such as that shown in FIG. 2A, the coupon sampler 210 may be operative coupled with the inert gas system 202 (and the actuation mechanism 204) via a coupling assembly 206. In one example, the coupling assembly 206 may be configured to establish a fluidic coupling between the coupon sampler 210 and the inert gas system 202. Additionally or alternatively, the coupling assembly 206 may be configured to define a pathway by which one or more components of the actuation mechanism 204 may engage the coupon device 220. For example, the coupling assembly 206 may provide a pathway by which the robotic grabber or the cable may advance through the system 200 for engagement with the coupon device 220 within an inner channel of the coupon sampler 210.

In this regard, in the example shown in FIG. 2A, the coupling assembly 206 is shown as include a coupling pipe portion 207, an isolation valve 208, and a coupling flange 209. The coupling pipe portion 207 may include a run of stainless steel or other material pipe by inert gas and/or components of the actuation mechanism 204 may reach the coupon device 220. The isolation valve 208 may be operable to control a flow of the inert gas to the coupon sampler 210, such as may be desired for disconnecting the upper assembly 240 (and the coupon device 220 held therein) from the system 200 subsequent to sampling. The isolation valve 208 may be integrated with the coupling pipe portion 207 in any appropriate manner such that isolation valve 208 may fully block the coupling pipe portion 207, and upon operation of the valve 208, return the coupling pipe portion 207 to a fully opened state. The flange 209 may be used to mechanically attach the coupling assembly 206 to the upper assembly 240, such as attaching the coupling assembly 206 to a flange or other connection piece of the upper assembly 240. In other examples, other components of the coupling assembly 206 are contemplated herein for delivery of the inert gas to the coupon device 220 and to support the actuation of the coupon device 220 within the coupon sampler 210. In some cases, one or more or all of the components of the coupling assembly 206 may be integrated into the upper assembly 240. For example, the upper assembly 240 may include one or more additional isolation valves proximal to the actuation mechanism 204 and/or the inert gas system 202. In this regard, each end of the upper assembly 240 may be fluidically isolated from any associated piping and process equipment prior to physical removal from the system 200. This may allow the upper assembly 240 to maintain an inert environment therein during and subsequent to disconnection from the system 200.

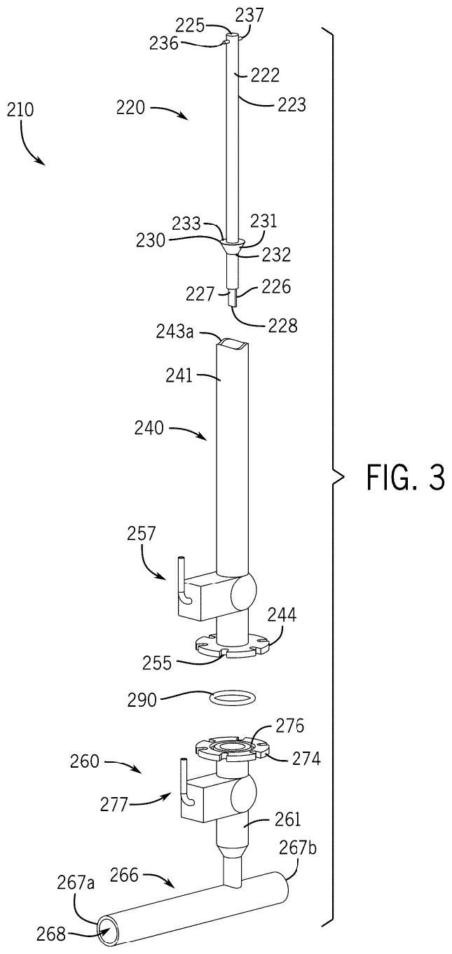

With reference to FIG. 3, an exploded view of the coupon sampler 210 is shown, including the coupon device 220, the upper assembly 240, the lower assembly 260, a sealing element 290. The coupon sampler 210 is configured to maintain an inert environment and to encompass the coupon device 220 fully within one or both of the upper assembly 240 and the lower assembly 260 during operation in such inert environment. Each of the coupon device 220, the upper assembly 240, and the lower assembly 260 will be described in turn below.

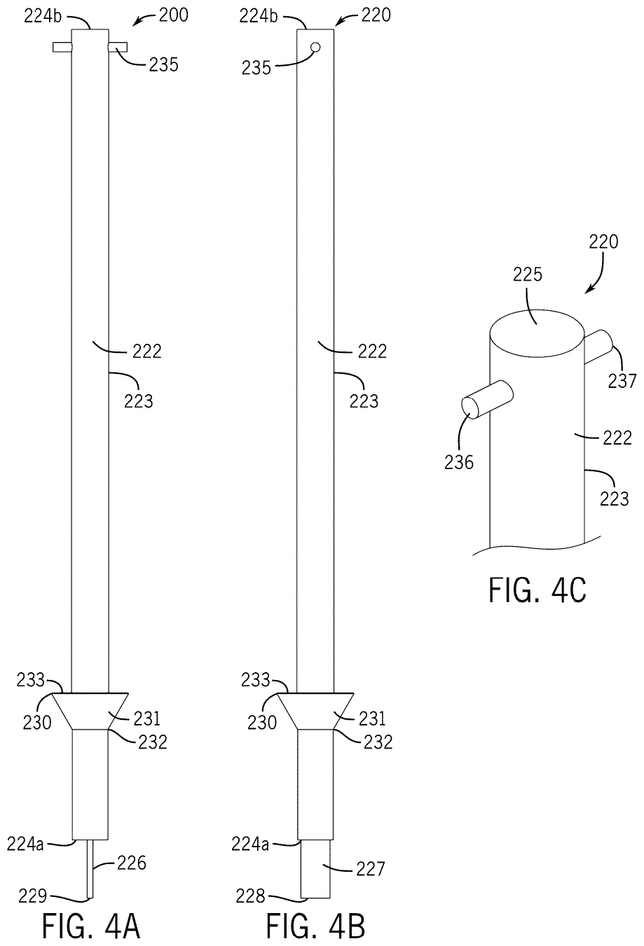

With reference to FIGS. 4A-4C, the coupon device 220 is shown. The coupon device 220 or coupon rod is shown a one-piece integrally formed structured. The coupon device 220 may be formed from a stainless steel material (e.g., SS316H or other material). While the coupon device 220 is shown in FIGS. 4A-4C as a one-piece structure, it will be appreciated that in other examples, the coupon device 220 may be an assembly of two or more components. In either case, the coupon device 220 may serve a variety of functions with the coupon sampler 210. For example, the coupon device 220 may allow for material characterization, and the coupon device 220 is itself the object performing the monitoring as at least a portion of the coupon device 220 is subject to the molten salt. Additionally, the coupon device 220 may control the motion of the coupon section or material tip. Additionally, the coupon device 220 may provide an attachment point for other subcomponents, including those subcomponents of the actuation system 204. Additionally, the coupon device 220 may be configured for actuation within the coupon sampler 210 via the magnetic coupling, the robotic grabber, the cable, the pressure differential, or by other means. Additionally, the coupon device 220 may serve to align the coupon tip or portion with respect to the flow of the molten salt. For example, the coupon device 220 may include various stop or other features to set maxim depth by which the coupon device 220 extend into the flow of molten salt.

To facilitate the foregoing, the coupon device 220 may be a monolithic structure of a stainless steel material. The coupon device 220 may be formed via machining. Additionally or alternatively, the coupon device 220 may be formed via segments, in particular for more precision and exotic coupon geometry. In the event that a portion of the coupon device 220 is segmented, the coupon device 220 may be welded together or mechanically threaded together in order to attach the constituent parts to one another.

In the monolithic structure shown in FIGS. 4A-4C, the coupon device 220 is shown as including an elongated portion 222, a coupon portion 226, a stop feature 230, and an engagement feature 235. The elongated portion 222 may define a cylindrical surface 223 extending from a first end 224a to the second end 224b to define the coupon device as a generally rod-shaped structure. In this regard, the elongated portion 222 may have a generally circular cross-section 225 extending between the first and second ends 224a, 224b. The coupon portion 226 may protrude from a bottom end of the elongated portion 222 and be configured for placement in the flow of the molten salt. For example, the coupon portion 226 may be a tip 228 or terminal end of the coupon device 220 that is dipped into the molten salt such that a portion of the coupon device 220 remains exposed to the molten salt over a selected period of time. The coupon portion 226 may have any appropriate geometry in order to facilitate the testing and analytical needs of the material sample. In the example shown in FIGS. 4A-4C, the coupon portion 226 is generally rectangular shape and has a paddle face 227 configured to face a flow of the molten salt. A thickness of the coupon portion 226 may be defined by an edge 229, which may have a cross-dimension that is substantially less than a cross-dimension of the paddle face 227. Such geometry may support the exposure of the coupon portion 226 to operational flow of the molten salt over time. In other cases, other geometries of the coupon portion 226 may be desirable.

The stop feature 230 is shown in FIGS. 4A-4C as being generally proximal to the second end 224a or the coupon device 220. The stop feature 230 may extend away from the elongated portion 222 in manner that allowed the stop feature 230 to define a maximum extent to which the coupon portion 206 is placed in the flow of the molten salt. For example, the stop feature 230 may defined by a conical surface 231 extending from a first edge 232 to a second edge 233. As described herein, the conical surface 231 may be complementary with one or more other components of the coupon sampler 210 such that the mating of the conical surface 231 with said complementary surface may prevent further movement of the coupon device 220 in at least one direction.

The engagement feature 235 may be any appropriate component integrated with the elongated structure 222 for operable coupling of the coupon device 220 with the actuation mechanism 202 or other actuation mechanism. For example, the engagement feature 235, as shown in FIGS. 4A-4C, may include a first engagement structure 236 and a second engagement structure 237, each protruding from the elongated structure 222 proximal the first end 224b. The first and second engagement structures 236, 237 may be cylindrical features, for example, that define a landing by which a robotic grabber can engage the coupon device 220 for actuation within the coupon sampler 210. Additionally or alternatively, the first and second engagement structures 236, 237 may include magnetic elements for magnetic coupling with a magnetic drive of the actuation mechanism 204. Additionally or alternatively, the first and second engagement structures 236, 237 may include a hook or other receiving structure for engagement with a cable of the actuation mechanism 204. Additionally or alternatively, the first and second engagement structures 236, 237 may include a flap, plunger or other mechanism via which a pressure differential can be maintained across the coupon device 220. In other examples, other applications and structures of the engagement structures and features are contemplated herein.

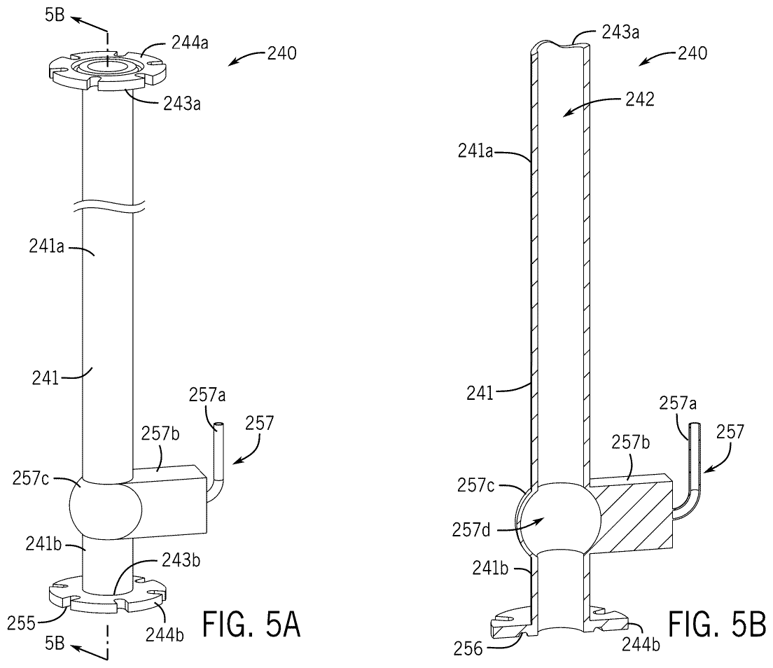

With reference to FIGS. 5A and 5B, the upper assembly 240 is shown. As described herein, the upper assembly 240 houses and contains the coupon device 220 before and after testing. The upper assembly 240 is shown as including an upper assembly pipe portion 241. The upper assembly pipe portion 241 may be a run of pipe, such as pipe formed from a stainless steel material. The upper assembly pipe portion 241 defines an upper channel 242 therethrough. The upper channel 242 may be configured to house the entirety of the coupon device 220. The upper assembly 240 is further shown as including an isolation valve 257 integrated with the upper assembly pipe portion 241. For example, the isolation valve 257 may be integrated with the upper assembly pipe portion 241 such that upper assembly pipe portion 241 is segmented into a first segment 241a and a second segment 241b. The upper channel 242 may defined by, and extend through, the first and second segments 241a, 241b and the isolation valve 257.

The isolation valve 257 may be configured to completely close and the fluidically isolate the first segment 241a from the second segment 241b. In one example, the isolation valve 257 may be an electrically actuatable full-port ball valve. In this regard, the isolation valve 257 is shown in FIG. 5A as including a valve handle 257a, a valve control unit 257b, a valve body 257c, and a valve port 257d. The valve handle 257a may indicate a position of the valve port 257d as being opened or closed. While the isolation valve 257 is electrically actuatable, the valve handle 257a may also allow for manual operation of the valve 257. The valve control unit 257b may be an electrically-actuated control system that includes components configured to mechanically manipulate a position of the valve portion 257d in response to an electrical signal. The valve body 257c is shown in FIGS. 5A and 5B as having a bulbous shape corresponding with the isolation valve 257 being a full portion ball valve. The valve port 257d may be or otherwise include a manipulated piece that is transitionable between a first state in which the valve 257 allows fluid to pass fully therethrough, and a second state in which valve 257 isolates and closes the upper assembly pipe portion from fluid flow. The isolation valve 257 is a non-wetted valve. That is, the molten salt flow is prevented or hindered from reaching the valve 257 and the valve 257 is allowed to seal without any fluid contact form the molten salt or other fluids. Establishing the isolation valve as a non-wetted valve may reduce sealing risks which could present themselves in the event that the molten salt were to encroach upon the valve. In other examples, other valves are possible. For example, the valve may additionally or alternatively be controlled by pressure or manual control.

The upper assembly pipe portion 241 is shown extending between a first end 243a and a second end 243b. The upper assembly 240 may include a first flange 244a at the first end 243a and a second flange 244b at the second end 243b. The first and second flanges 244a, 244b may allow the upper assembly 240 to be mechanically and fluidically attached to associated process equipment of the system 200. For example, the first flange 244a may be used to attach the upper assembly 240 to the coupling assembly 206 of FIG. 2A and the second flange 244b may be used to attach the upper assembly 240 to the lower assembly 260. The second flange 244b is shown in FIGS. 5A and 5B as having flange fasteners holes 255 and a sealing groove 256. The fastener holes 255 may be circumferentially spaced slots about a periphery of the flange 244b that are configured to receive a bolt or other fastener. The sealing groove 256 may be configured to receive a sealing element, such as an O-ring, for maintaining a fluid-tight connection with an adjoining process component. In other examples, additional or different components may be incorporated into the upper assembly 240 including addition or different valves, instruments, and ports, as may be needed for a given application.

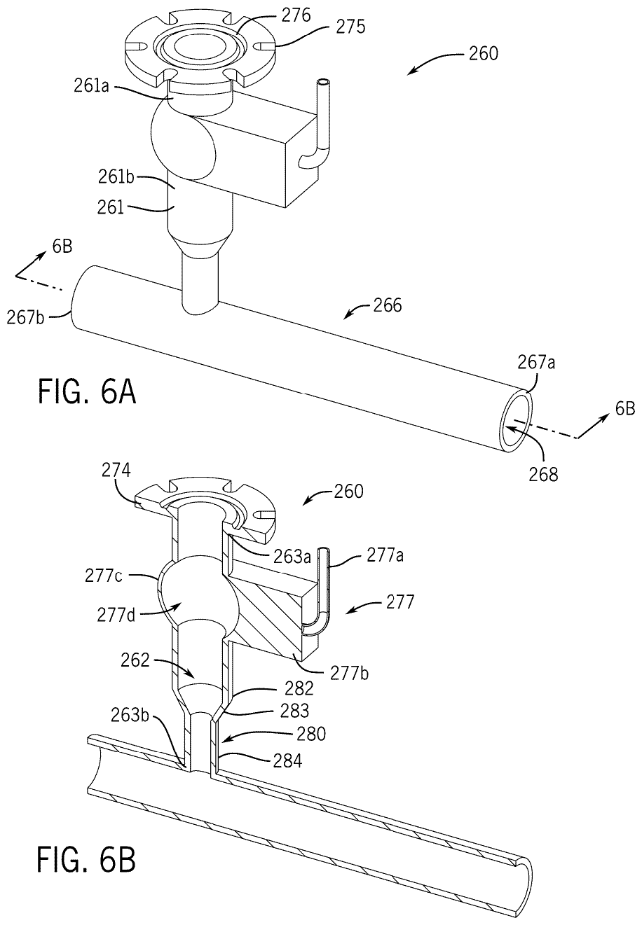

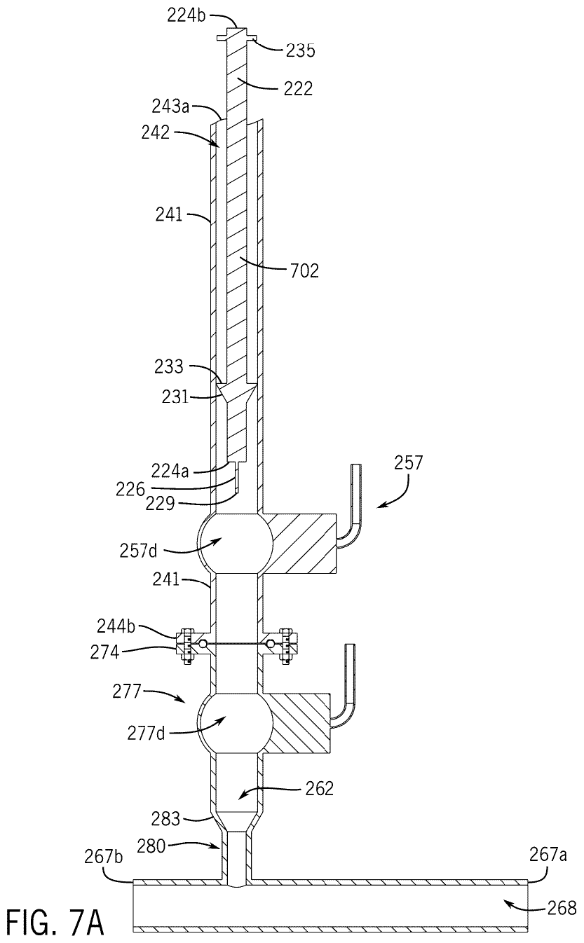

With reference to FIGS. 6A and 6B, the lower assembly 260 is shown. As described herein, the lower assembly 260 houses and contains a portion of the coupon device 220 during sampling. For example, the lower assembly 260 is configured to receive the coupon device 220 and guide the coupon device 220 toward the flow of the molten salt. The lower assembly 260 further serves to stop the coupon device 220 at a specified depth before hitting the bottom of the pipe through the operational flow of the molten salt progresses. The lower assembly 260 further cooperates with the upper assembly 240 to crush the sealing element therebetween such that the lower assembly 260 and the upper assembly 240 define a continuous sampling channel therethrough.

The lower assembly 260 is shown as including a lower assembly pipe portion 261. The lower assembly pipe portion 261 may be a run of pipe, such as pipe formed from a stainless steel material. The lower assembly pipe portion 261 defines a lower channel 262 therethrough. The lower channel 262 may be configured to house and align at least a portion of the of the coupon device 220. The lower assembly 260 is further shown as including an isolation valve 277 integrated with the lower assembly pipe portion 261. For example, the isolation valve 277 may be integrated with the lower assembly pipe portion 261 such that lower assembly pipe portion 261 is segmented into a first segment 261a and a second segment 261b. The lower channel 262 may defined by, and extend through, the first and second segments 261a, 261b and the isolation valve 277. The isolation valve 277 may be substantially analogous to the isolation valve 257 and include a valve handle 257a, a valve control unit 257b, a valve body 257c, and a valve portion 257d, redundant explanation of which is omitted here for clarity.

The lower assembly pipe portion 261 is shown extending between a first end 263a and a second end 263b. The lower assembly 260 may include a flange 274 at the first end 263a and a transition piece at the second end 263b. The flange 274 may allow the lower assembly 260 to be mechanically and fluidically attached to associated process equipment of the system 200. For example, the flange 274 may be used to attach the lower assembly 260 to the the upper assembly 240. The flange 274 is shown in FIGS. 6A and 6B as having flange fasteners holes 275 and a sealing groove 276, which may be substantially analogous to the fastener holes 255 and the sealing groove 256, as described herein.

The lower assembly 260 is further shown as including the transition piece 280. The transition piece 280 may be a guide or a collar that is operable to direct the coupon device 220 toward a flow of molten salt. For example, the lower assembly 260 may include an in-line portion 266 through which is operable to have a flow of molten salt pass therethrough. For example, the in-line portion 266 may be a pipe having a first pipe connection end 267a and second pipe connection end 267b and defining a flow channel 268 therethrough. In operation, the in-line portion 266 may optionally be arranged fluidically between the various components of the molten salt loop shown and described herein in relation to the system of FIG. 1. The transition piece 280 is fluidically coupled with and extends transverse from, such as extending perpendicular therefrom, the in-line portion 266. The transition piece 280 therefore establishes a flow path between the lower assembly pipe portion 261 and the in-line portion 266. While many different constructions of the transition piece 280 are possible, the transition piece 280 is shown in FIGS. 6A and 6B as including an angled transition portion 282 that defines a generally conical shape 283. The transition piece is also shown as including a neck 284. As explained herein, the angled transition portion 282 may be configured for mating engagement with one or more features of the coupon device 220 in order to limit the advancement of the coupon device 220 into the in-line portion 266. Further, the neck 284 may be configured to match a diameter or contour of the coupon device 220 in order to mitigate the flow of molten salt through the transition piece 280 when the coupon device 220 is arranged in the sampling position. In other examples, additional or different components may be incorporated into the upper assembly 240 including addition or different valves, instruments, and ports, as may be needed for a given application.

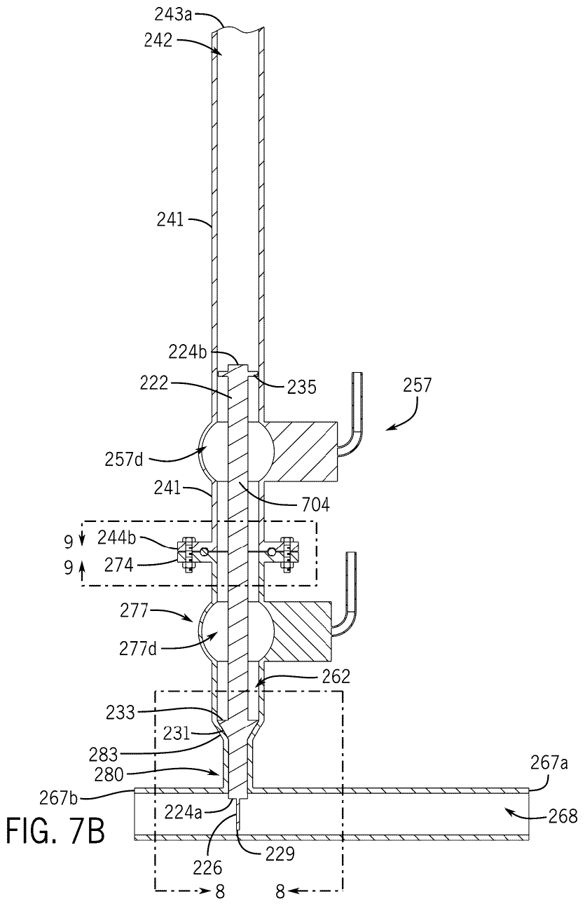

With reference to FIGS. 7A and 7B, a cross-sectional view of the coupon sampler 210 is shown. The coupon sampler 210 is shown in FIGS. 7A and 7B in an assembled position in which the upper assembly 240 and the lower assembly 260 are removably coupled to one another to form a combined assembly. For example, and as shown in the detail 9-9 of FIG. 9, the flange 244b of the upper assembly 240 is shown mated with the flange 274 of the lower assembly 260. In the mated configured shown in FIG. 9, the sealing element 290 is arranged in the sealing groove 256 of the flange 244b and the sealing groove 276 of the flange 274. The flanges 244b, 274 may operable to crush the sealing element 290 therein and to connect the lower assembly 260 and the upper assembly 240 to one another. For example, and as shown in FIG. 9, fastener 292, such as bolts, may be used to clamp and compress the flanges 244b, 274 toward one another. The fasteners 292 may be disposed in corresponding ones of the sealing grooves 256, 276.

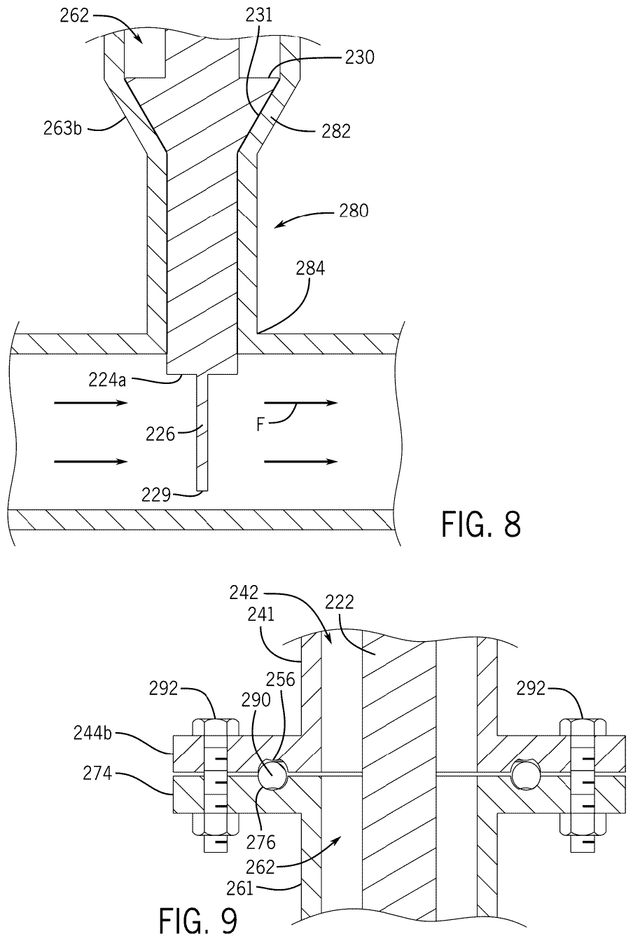

As described herein, the coupon sampler 210 may be configured to actuate and move the coupon device 220 therein. In this regard, FIG. 7A shows the coupon device 220 in an isolation position 702. In the isolation position 702, the coupon device 220 may be fully disposed with the upper channel 242 of the upper assembly 240. For example, the coupon device 220 may be fully disposed within the portion of the upper channel 242 defined solely by the first segment 241a. At the isolation position 702, the coupon device 220 may be fully encompassed by an inert gas, such as that supplied by the inert gas system 202. In turn, FIG. 7B shows the coupon device 220 in a sampling position 704. In the sampling position 704, the coupon device 210 may be at least partially disposed within a flow F of a molten salt, as shown with reference to detail 8-8 of FIG. 8. For example, the coupon portion 226 may be arranged within the flow F of the molten salt. The coupon portion 226 may remain in the flow F of the molten salt during the sampling time period. As described herein, the coupon sampler 210 may move the coupon device 220 between the isolation position 702 and the sampling position 704 via the actuation mechanism 204.

With continued reference to FIG. 8, the lower assembly 260 is show in a mating engagement with the coupon device 220 such that lower assembly 260 limits the advancement of the coupon device 220 in the flow F. For example, the angled transition portion 282 of the transition piece 280 is shown engaged with, and complementary with, the conical face 231 of the stop feature 230 of the coupon device 220. Such engagement prevents the coupon device 220 from further advancement into the flow F. Further, the neck 284 of the transition piece 280 is shown matching the shape and diameter of the elongated portion 222. In this regard, when the coupon device 220 is seated on the lower portion 260, the transition piece 280 may operate to limit the advancement of fluid flow into the lower channel 262 and into the coupon sampler 210 more generally.

As described herein, the coupon device 220 may include or otherwise be associated with any of a variety of actuation mechanisms that are configured to causes a movement of the coupon device 220 therein. With reference to FIGS. 10-14, various example actuation mechanism are presented herein for purposes of example. It will be appreciated that in other cases other actuation mechanism, including variations of the actuation mechanism shown and described, may be used

With reference to FIGS. 10-11B, a system 1000 is shown. The system 1000 may be substantially analogous to the system 200, and include the coupon sampler 210 shown therein. Notwithstanding the foregoing similarities, the system 1000 may be configured to magnetically drive or actuate the coupon device 220 of the coupon sampler 210. For example, the system 1000 may include a magnetic drive 1010. The magnetic drive 1010 may generally include a shaft 1014, a magnetic field generator 1018, and a handle 1022. In other cases, more or different components may be used for the magnetic drive 1010. The magnetic field generator 1018 may include or be a magnet. The shaft 1014 may extend from the magnetic drive 1014 to the handle 1022. The handle 1022 may be a component that associated the shaft 1014 with another mechanism for moving the shaft 1014 and the magnetic field generator 1018 relative to the coupon sampler 210.

In operation, and as shown in FIG. 11A, the magnetic field generator 1018 may be placed proximal to the engagement feature 235 of the coupon device 220. In this example, the engagement feature 235 may include various ferromagnetic components that are responsive to the magnetic field generator 1018 by the magnetic field generator 1018. Subsequently, the magnetic field generator 1018 may be moved, and in so doing, such movement may cause a corresponding movement of the coupon device 220 via the magnetic coupling of the engagement feature 235 with the magnetic field generator 1018. In this regard, the magnetic drive 1010 may reposition the magnetic field generator 1018 and cause the coupon device 220 to move from the isolation position shown in FIG. 11A to the sampling position of FIG. 11B. The magnetic drive 1010 may be further operable to reverse such movement in order to move the coupon device 220 from the sampling position of FIG. 11B and back to the isolation position of FIG. 11A.

With reference to FIGS. 12A-12C, a system 1200 is shown. The system 1200 may be substantially analogous to the system 200, and include the coupon sampler 210 shown therein. Notwithstanding the foregoing similarities, the system 1200 may be configured to actuate and manipulate the coupon device 220 via a robotic coupler 1210. The robotic coupler 1210 may generally include a shaft 1214, one or more slotted features 1216, a hook 1218, a seat 1219, an articulation 1220, a linkage 1222, and an articulation 1224. The shaft 1214 may be configured for insertion into the channel of the coupon sampler 210. The shaft 1214 may define a sleeve or other tubular structure having one or more slotted features 1216 at a terminal end of the shaft 1214. Within at least one of the slotted features 1216, the robotic coupler 1210 may include the hook 1218, which is shown in FIGS. 12B and 12C as having the seat 1219 defined thereon. In one example, the hook 1218 may be attached to the shaft 1214 at the articulation 1220 and allowed to pivot thereabout. The hook 1218 may be further coupled to the linkage 1222 at the articulation 1224 and allowed to pivot thereabout. The linkage 1222 may be disposed within the shaft 1214 and operable to move therein, for example, by a motor or other actuation element. Movement of the linkage 1222 in this manner may cause a pivoting movement of the hook 1218.

In operation, and as shown in FIGS. 12B and 12C, the robotic coupler 1210 may be advanced into the upper channel 242 and proximate the engagement feature 235 of the coupon device 210. The linkage 1222 may be actuated to move the hook 1218 in a manner such that the hook 1218 accommodates one or both of the engagement structures 236, 237 at the seat 1219. In this regard, the hook 1218 may be manipulated in order to retain the coupon device 220 relative to the robotic coupler 1210 via the engagement of the hook 1218 and the engagement feature 235. Subsequently the robotic coupler 1210 may be moved within the upper channel 242 and thereby cause a corresponding movement of the coupon device 220 between the isolation position and the sampling position.

With reference to FIG. 13, a system 1300 is shown. The system 1300 may be substantially analogous to the system 200, and include the coupon sampler 210 shown therein. Notwithstanding the foregoing similarities, the system 1300 may be configured to drive or actuate the coupon device 220 using a cable 1310. For example, and as shown in FIG. 13, the cable 1310 may be advanced into the upper channel 242 of the upper assembly 240. A loop portion 1314 of the cable 1310 may be fastened or otherwise coupled to the coupon device 220. For example, in the configuration of FIG. 13, the coupon device 220 may include an engagement feature 235′ having an engagement structure 236′ that is generally a curved feature that define a slotted space 238. The loop portion 1314 is configured to grab the coupon device 220 at the slotted space 238. In this regard, the cable 1310 may be subsequently moved, which may cause a corresponding movement of the coupon device 220, such as a movement of the coupon device 220 between the isolation position and the sampling position.

With reference to FIG. 14, a system 1400 is shown. The system 1400 may be substantially analogous to the system 200, and include the coupon sampler 210 shown therein. Notwithstanding the foregoing similarities, the system 1400 may be configured to move the coupon device 220 within the coupon sampler 210 by inducing a pressure differential across the coupon device 220. For example, in the configuration of FIG. 14, the coupon device 220 may include an engagement feature 235″ that is defined by a plunger, flap, or other mechanism that allows for a pressure differential to be established on either side. In this regard, with the upper channel 242, the engagement feature 235″ may define a boundary between a region of the upper channel 242 having a first pressure P₁ and a region of the upper channel having a second pressure P₂. The pressure P₁, P₂ may be controlled to cause a movement of the coupon device 220 between the isolation position and the sampling position. For example, the pressure P₁, P₂ may be controlled such that where the pressure P₂ is greater than P₁, the coupon device 220 may be encouraged downward toward the sampling position. Further, the pressure P₁, P₂ may be controlled such that where the pressure P₁ is greater than P₂, the coupon device 220 may be encouraged upward toward the isolation position.

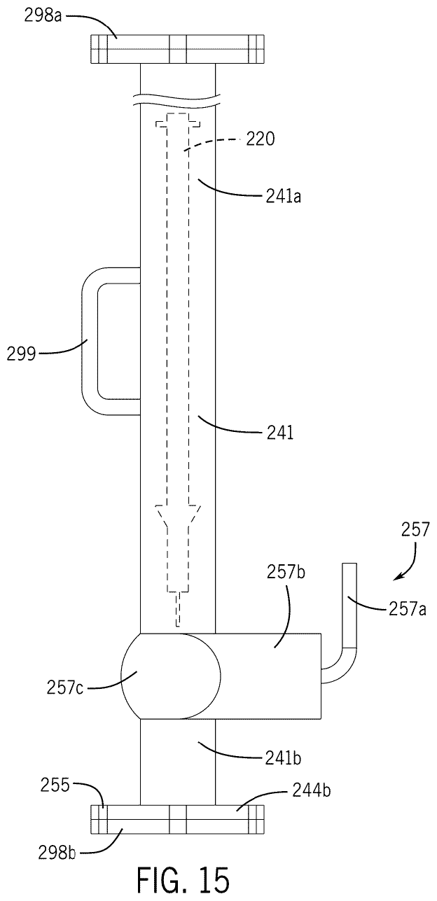

On conclusion of sampling, the actuation mechanism may generally return the coupon device 220 to the isolation position, for example, using any of the actuation mechanisms described herein. Once returned to the isolation position, the coupon device 220 may be operable to close and fluidically isolate the coupon device 220 from the flow of molten salt. For example, the actuation mechanism may raise the coupon device 220 into the first segment 241a of the upper pipe portion 241 (which maintains an inert environment therein), as shown with reference to FIG. 15. Subsequently, the isolation valve 257 may be shut to close the first segment 241a from the lower assembly 260 and the molten salt flow associated therewith. This may allow the upper assembly 240 to be separated from the lower assembly 260 and to be caped with one or more flange caps 298a, 298b. Accordingly, the upper assembly 240 may be operable to maintain the coupon device 220 therein while the upper assembly 240 is transported to another location. In some cases, the upper assembly 240 may include a handle 299 or other feature to facilitate handing of the upper assembly 240 and movement to another location. In this regard, the upper assembly 240 may be transported to another location in which the upper assembly 240 can be opened in an inert environment such that the coupon device 220 remains in an inert environment during subsequent analysis of the material coupon. Maintaining the coupon device 220 in an inert environment at all times may promote and enhance the validity of the testing.

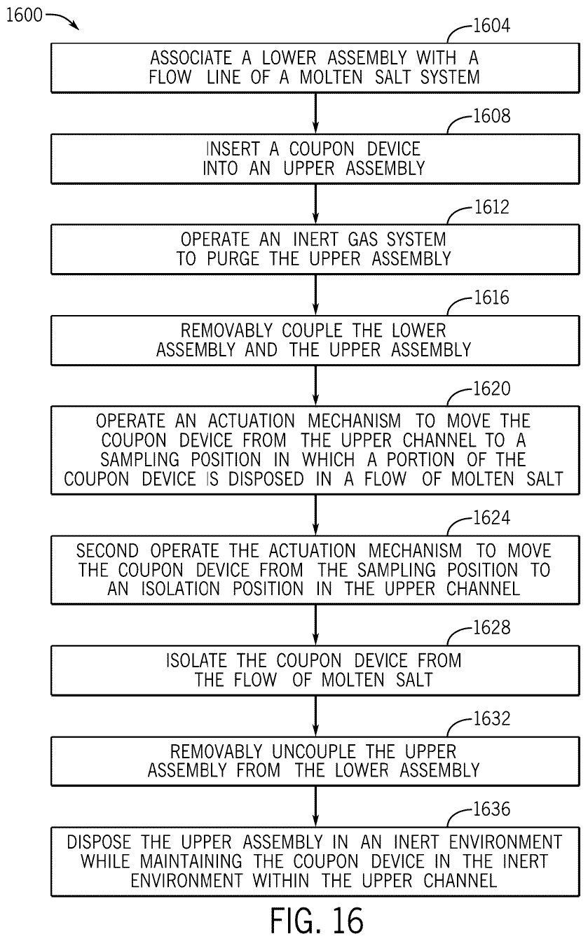

FIG. 16 depicts a flow diagram of an example method of operating a coupon sampler. At operation 1604, a lower assembly is associated with a flow line of the a molten salt system. For example, and with reference to FIGS. 1 and 2A, the in-line portion 266 of the lower assembly 260 may be associated with any flow line shown in the system 100, such as the flow lines between one or more of the reactor vessel 102, the pump 104, the heat exchanger 106, and/or the drain tank 108.

At operation 1608, a coupon device is inserted into the upper assembly. For example, and with reference to FIGS. 7A, the coupon device 220 may be inserted into the upper channel 242 of the upper assembly 240. At operation 1612, an inert gas system is operated to purge the upper assembly. For example, and with reference to FIGS. 2A and 7A, the inert gas system 202 may operate to introduce inert gas into the upper channel 242 in order to displace room air and to encompass the coupon device 220 in the inert gas. At operation 1616, the lower assembly is removably coupled with the upper assembly. For example, and with reference to FIGS. 2A, 7B, and 9, the lower assembly 260 may be coupled to the upper assembly 240 via a pair of mating flanges and a sealing element. For example, and as shown in FIG. 9, the flanges 244b, 274 may operable to crush the sealing element 290 therein and to connect the lower assembly 260 and the upper assembly 240 to one another. In some cases, fastener 292, such as bolts, may be used to clamp and compress the flanges 244b, 274 toward one another. The fasteners 292 may be disposed in corresponding ones of the sealing grooves 256, 276.

At operation 1620, an actuation mechanism is operated to move the coupon device from the upper channel to a sampling position in which a portion of the coupon device is disposed in a flow of molten salt. For example, and with reference to FIGS. 2A, 7A, and 7B, the actuation mechanism may operate to move the coupon device 220 from the isolation position 702 to the sampling position 704. At operation 1624, the actuation mechanism is operated to move the coupon device from the sampling position to an isolation position in the upper channel. For example, and with reference to FIGS. 2A, 7A, and 7B, the actuation mechanism may operate to move the coupon device 220 from the sampling position 704 back to the isolation position 702. To facilitate the foregoing operations, the actuation mechanism 204 may utilize one or more of a magnetic coupling, a robotic coupler, a cable, or a pressure differential. In some cases, the coupon device 220 may moved between the isolation position 702 and the sampling position by hand, such as by hand tooling, including pliers.

At operation 1628, the coupon device is isolated from the flow of molten salt. For example, and with reference to FIG. 7A, in the isolation position 702 the coupon device 220 may be fully disposed within the first segment 241a of the upper assembly pipe portion 241. In this regard, the isolation valve 257 may be operated to close and fluidically separate the coupon device 220 from the flow of molten salt associated with the lower assembly 260. At operation 1632, the upper assembly is removably uncoupled from the lower assembly. For example, and with reference to FIGS. 7A and 9, the fasteners 292 may be loosened or otherwise manipulated such that that flanges 244b, 274 are releasable from one another. In some cases, a flange cap, may be associated with opposing end of the upper assembly, such as that shown in FIG. 14 herein. At operation 1636, the upper assembly is disposed in an inert environment while maintaining the coupon device in the inert environment within the upper channel. For example, and with reference to FIG. 14, the upper assembly 240, including the coupon device 220 contained in an inert environment therein, may be moved to an inert environment at another location. In this regard, the upper assembly 240 may be subsequently opened in order to remove the coupon device 220 for analysis in such inert environment, thereby promoting the validity of the testing on the coupon device 220.

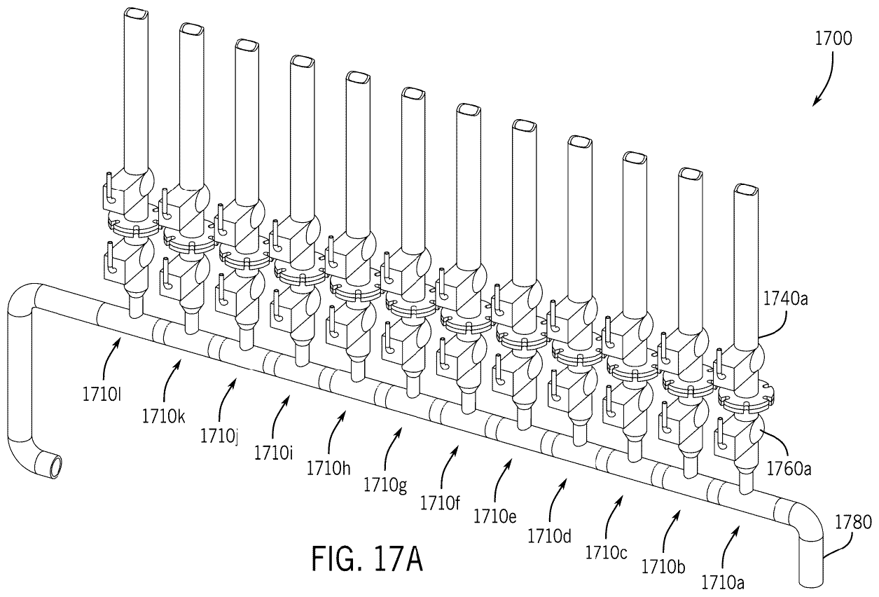

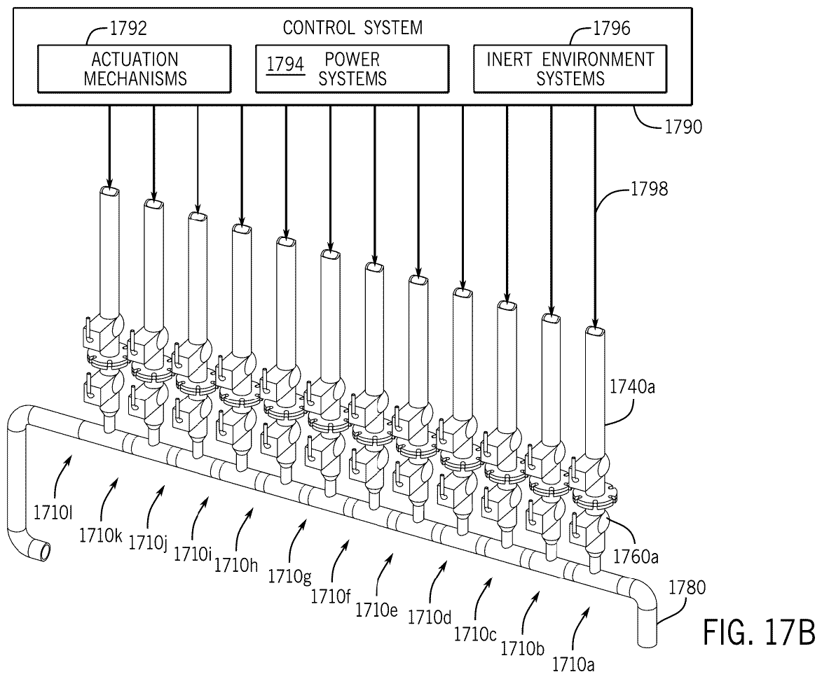

FIG. 17A depicts an example sampling array 1700. The sampling array 1700 may be configured to monitor corrosion in a molten salt loop over time, for example, such as by employing multiple material coupons in the molten salt and selectively removing the coupons for analysis at a predetermined, regular time period. In this regard, the sampling array 1700 of FIG. 17A is shown with a first coupon sampler 1710a, a second coupon sampler 1710b, a third coupon sampler 1710c, a fourth coupon sampler 1710d, a fifth coupon sample 1710e, a sixth coupon sampler 1710f, a seventh coupon sampler 1710g, an eighth coupon sampler 1710h, a nineth coupon sampler 1710i, an eleventh coupon sampler 1710j, and a twelfth coupon sampler 17101. Each of the coupon samplers 1710a-17101 may be substantially analogous to any of the coupon samplers described herein, such as the coupon sampler 210, and may therefore include an upper assembly 1740a and a lower assembly 1760a. A through portion of each of the coupon samplers 1710a-17101 is shown connected along and defining a pipe run 1780. Each of the coupon samplers 1710a-17101 may include a material coupon that is selectively insertable into the a flow of molten salt that is circulated through the pipe run 1780, according to any of the example described herein.

In this regard, and as shown in relation to FIG. 17B, each of the coupon samplers 1710a-17101 may be associated with a control system 1790. The control system 1790 may be connected to the sampling array 1700 via the operable connection 1798. The control system 1790 may substantially analogous to the various control systems described herein such that the control system be operable to selectively lower and raise a material coupon into the pipe run 1780 while maintaining an inert environment about the material coupon. To facilitate the foregoing, the control system 1790 is shown schematically as including actuation mechanisms 1792, power systems 1794, and inert environment system 1796, among other potential systems. The actuation mechanisms 1792 may be adapted to raise and lower a material coupon of any of the coupon samplers 1710a-17101, such as that described in relation to the actuation mechanism 204 herein. The power systems 1794 may provide electrical power and/or pneumatic or other control to the actuation mechanisms 1792 in order to facilitate the selective lowering and raising of the material coupon. In some cases, the power systems 1794 may include a coupling to a power system of the reactor or plant within which the sampling array 1700 is located. The inert environment system 1796 may be operated to maintain an inert environment within each of the coupon samplers 1710a-1710l, such as that described in relation to the inert gas system 202 of FIG. 2. Accordingly, the control systems 1790 may provide a common control or common system by which to provide each of the individual coupon samplers 1710a-1710l with actuation control, power, and/or an inert environment. It will be appreciated that in other examples, other configurations of the control system 1790 are possible, including where the control system 1790 is defined by multiple discrete subsystems.

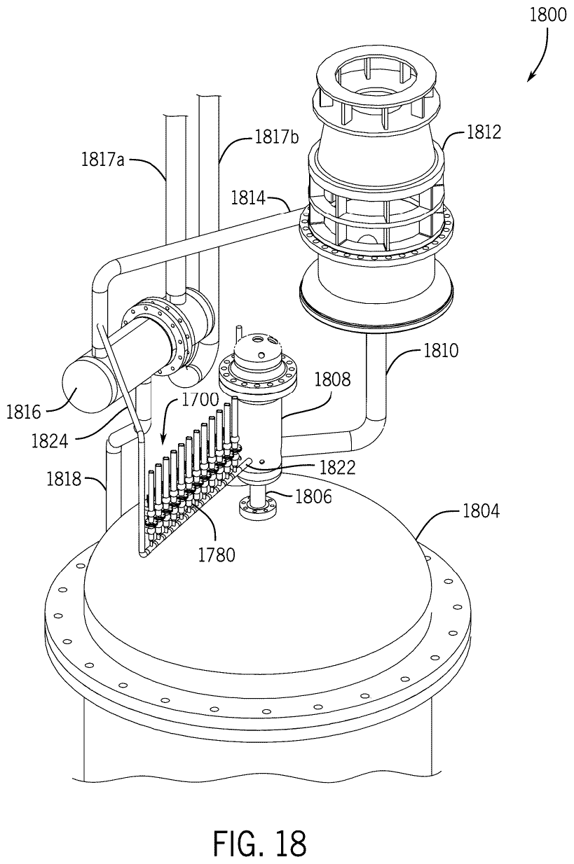

With reference to FIG. 18, an example reactor system 1800 is depicted that implements the coupon sampling array 1700 described above in relation to FIGS. 17A-17B. For example, a reactor system 1800 is shown that may be substantially analogous to the reactor system 100 shown in relation to FIG. 1, and include a reactor vessel 1804, a reactor access vessel 1808, a pump 1812, and a heat exchanger 1816, redundant explanation of which is omitted herein for clarity. As shown in FIG. 18, the reactor vessel 1804, the reactor access vessel 1808, the pump 1812, and the heat exchanger 1816 are fluidically coupled along a molten salt “loop”, in which the a molten salt is flowable from the reactor vessel 1804 to the reactor access vessel 1808 via a pipe segment 1806, the molten salt is further flowable from the reactor access vessel 1808 to the pump 1812 via a pipe segment 1810, the molten salt is further flowable from the pump 1812 to the heat exchanger 1818 via the pipe segment 1814, and the molten salt is further flowable from the heat exchanger 1818 back to the reactor vessel 1804 via the pipe segment 1818. The system 1800 is further shown with coolant cold leg 1817a, and a coolant hot leg 1817b for circulating coolant with the heat exchanger 1818 to remove heat from the molten salt of the loop.

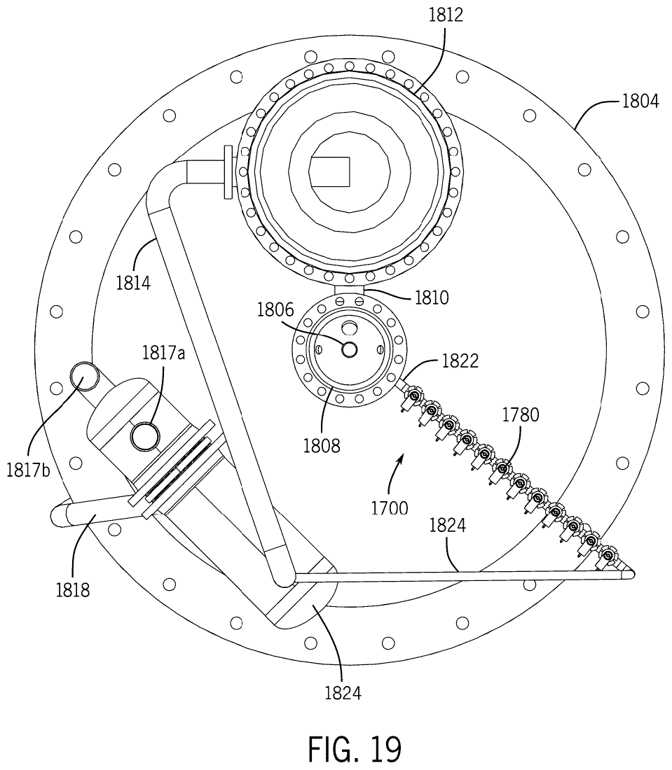

The coupon array 1700 may be arranged and fluidically coupled within the reactor system 1800 in order to receive a flow of the molten salt from the molten salt loop. In the example, of FIG. 18, and as further illustrated in FIG. 19, the coupon array 1700 may be positioned as a cut-back line between the reactor access vessel 1808 and the pipe segment 1814 (which may be the discharge line of the pump 1812). Specifically, the coupon array 1700 may be arranged such that the pipe run 1780 receives a flow of molten salt from a pipe segment 1824 that comes off of the pipe run 1814. The molten salt may progress through the pipe run 1780 and encounter the various material coupons positioned therein. The molten salt may further exit the coupon array 1700 via the pipe run 1822, which may empty into the reactor access vessel 1808, which it is reintroduced into the flow of molten salt of the loop. In this regard, the coupon array 1700 may be adapted to measure corrosion in the system over time by removing select one of the material coupons at regular intervals, such as every six months.

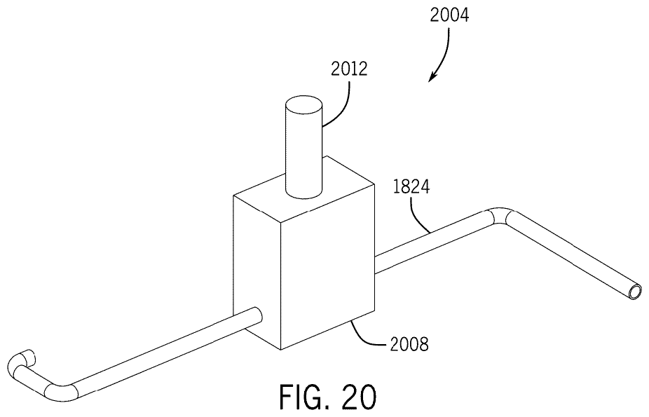

FIG. 20 depicts an example salt sampling mechanism 2004 of the example sampling array 1700. For example, the sampling array 1700 may, in addition to the material coupons described herein, include one or more salt sampling systems that operates to sample the molten salt (such as sampling a content of the salt and otherwise retrieving the salt for analysis of the material and chemical properties of the salt), such as that described in U.S. patent application Ser. No. 18/056,883, which is incorporated by reference herein. In this regard, for purposes of illustration, the sampling mechanism 2004 is shown as including an example sampling box 2008, which may generally include any of a variety of components for physically receiving and collecting a volume of salt, and an example, sampling device 2012, which may include any of variety of components for retrieving the salt and maintaining an inert environment therearound. The combination of the sampling mechanism 2004 with the sampling array 1700 may provide for a compact and efficient arrangement of both salt and coupon-based sampling along a single cut-back line of the molten salt reactor system 1800.

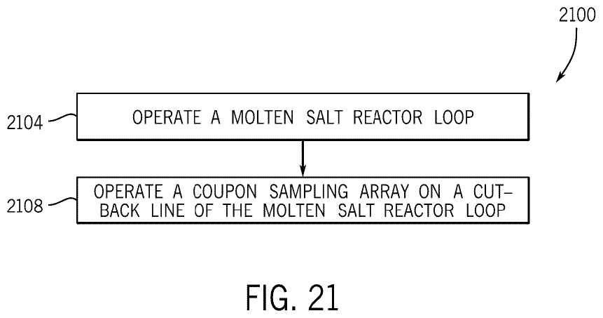

FIG. 21 depicts a flow diagram of an example method 2100 of operating a reactor system. At operation 2104, a molten salt reactor loop is operated. For example, and with reference to FIGS. 18 and 19, the molten salt of the reactor system 1800 may be operated by causing a circulation of the molten salt through each of the reactor vessel 1804, the reactor access vessel 1808, the pump 1812, and the heat exchanger 1816. Through such operation, as described herein, the reactor system 1800 may operate to generate heat that is removed via the heat exchanger 1816. At operation 2108, a coupon sampling array is operated on a cut-back line of the molten salt reactor loop. For example, and with continued reference to FIGS. 18 and 19, a flow of molten salt is introduced to the sampling array 1700 via the pipe segment 1824. The pipe segment may receive molten salt from a discharge of the pump 1812. From the pipe segment 1824, the molten salt may encounter each and every one of the material coupons that are arranged in the pipe run 1780. The molten salt may continue through the sampling array 1700 and exit the sampling array 1700 via the pipe run 1822, into the reactor access vessel 1808. By exposing multiple material coupons to the molten salt simultaneously, select material coupons may be removed from the molten salt at predefined intervals in order to measure a corrosivity and other properties of the system 1800 over time.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A coupon sampler for a reactor system, the coupon sampler comprising
a lower assembly having an in-line portion configured to receive a flow of a molten salt, and a lower assembly pipe portion extending transverse from the in-line portion and defining a lower channel therethrough;
an upper assembly fluidically coupled with the lower assembly and having an upper assembly pipe portion defining an upper channel therethrough and cooperating with the lower channel to define a sampling channel of the coupon sampler;
a coupon device disposed fully within the sampling channel; and
an actuation mechanism operatively coupled with the coupon device and configured to move the coupon device axially into and out of the flow of the molten salt.

2. The coupon sampler of claim 1, further comprising an inert gas system configured to maintain an inert environment in the sampling channel.

3. The coupon sampler of claim 1, wherein
the lower assembly comprises a first isolation valve integrated with the lower assembly pipe portion and configured to block flow through the lower channel, and
the upper assembly comprises a second isolation valve integrated with the upper assembly pipe portion and configured to block flow through the upper channel.

4. The coupon sampler of claim 3, wherein the actuation mechanism is configured to move the coupon device between
an isolation position in which the coupon device is disposed fully within the upper channel, and
a sampling position in which the coupon device is disposed at least partially in both the lower channel and the flow of molten salt.

5. The coupon sampler of claim 4, wherein
in the isolation position, each of the first isolation valve and the second isolation valve are closeable to block flow through the respective upper channel and lower channel and to fluidically isolate the coupon device from the flow of molten salt, and
in the sampling position, each of the first isolation valve and the second isolation valve remain open and allow at least a portion of the coupon device to be disposed therethrough.

6. The coupon sampler of claim 5, wherein, in the isolation position, the upper assembly, having the coupon device disposed fully within, is separable from the lower assembly, and wherein the upper assembly maintains the coupon device in an inert environment subsequent to separation of the upper assembly from the lower assembly.

7. The coupon sampler of claim 6, further comprising a pair of flange caps, each flange cap of the pair of flange caps coupled to an opposing end of the upper assembly pipe portion and establishing a sealed barrier between the upper channel and an external environment.

8. The coupon sampler of claim 5, wherein each of the first isolation valve and the second isolation valve are non-wetted valves.

9. The coupon sampler of claim 5, wherein each of the first isolation valve and the second isolation valve are full-port ball valves.

10. The coupon sampler of claim 1, wherein the coupon device is a one-piece structure.

11. The coupon sampler of claim 10, wherein the coupon device comprises
an elongated portion extending axially through the sampling channel,
a coupon portion protruding from a bottom end of the elongated portion and configured for placement in the flow of the molten salt,
an engagement feature protruding from a top end of the elongated portion opposite the bottom end and configured for operable coupling with the actuation mechanism, and
a stop feature proximal the bottom end extending away from the elongated portion, the stop feature being configured to define a maximum extent to which the coupon portion is placed in the flow of the molten salt.

12. The coupon sampler of claim 11, wherein
the stop feature comprises a conical structure extending about a circumference of the elongated portion of the coupon device,
the lower assembly comprises a transition piece fluidically between the lower assembly pipe portion and the in-line portion, the transition piece having an angled transition portion complementary in shape to the conical structure of the coupon device,
wherein the actuation mechanism axially moves the coupon device along the sampling channel, and
wherein a mating of the conical structure and angled transition portion defines a lower boundary of the axial movement of the coupon device within the sampling channel.

13. A coupon sampler for a reactor system, the coupon sampler comprising
a combined assembly defining a sampling channel therethrough, the sampling channel comprising an inert gas;
a pair of isolation valves integrated in series with the sampling channel, each isolation valve of the pair of isolation valves being configured to block flow through the sampling channel;
a coupon portion disposed within the sampling channel and being axially moveable therein between
a sampling position in which the coupon portion is disposed at least partially in a flow of molten salt, and
an isolation position in which the coupon portion is disposed within the sampling channel fully encompassed by the inert gas and fluidically isolated from the molten salt by the closure of each of the pair of isolation valves.

14. The coupon sampler of claim 13, wherein
the combined assembly comprises
a lower assembly defining a lower channel therethrough,
an upper assembly defining an upper channel therethrough, the upper channel and the lower channel cooperating to define the sampling channel, and
a sealing element defining a sealed barrier between the lower assembly and the upper assembly.

15. The coupon sampler of claim 14, wherein, in the isolation position,
the coupon portion is disposed fully within the upper channel, and
the upper channel is separable from the lower assembly at the sealing element while maintaining the coupon portion in the inert environment of the upper channel.

16. The coupon sampler of claim 15, wherein the coupon portion defines a tip of a coupon device disposed fully within the sampling channel, the coupon device being actuatable by an actuation mechanism between the sampling position and the isolation position.

17. The coupon sampler of claim 16, further comprising the actuation mechanism, the actuation mechanism being configured to actuate the coupon device using one or more of
a magnetic coupling,
a robotic coupler,
a cable, or
a pressure differential.

18. The coupon sampler of claim 16, wherein the coupon device is a one-piece structure formed from a stainless steel material.

19. The coupon sampler of claim 18, wherein the coupon device includes a stop feature configured to limit an entry of the coupon portion into the flow of molten salt.

20. The coupon sampler of claim 19, wherein the stop feature comprises a conical collar that extends from an elongated body of the coupon device a distance that exceeds a diameter of a transition piece that is arranged fluidically between the sampling channel and the flow of molten salt.

21. A method of operating a coupon sampler for a reactor system, the method comprising
associating an in-line portion of a lower assembly with a flow line of a molten salt system, the lower assembly including a lower assembly pipe portion extending transverse from the in-line portion and defining a lower channel therethrough;
inserting a coupon device into an upper channel of an upper assembly;
operating an inert gas system to purge room air from the upper assembly with inert gas;
removably coupling the lower assembly and the upper assembly to one another such that the lower channel and the upper channel define a continuous sampling channel; and
operating an actuation mechanism to move the coupon device from the upper channel to a sampling position in which a portion of the coupon device is disposed in the flow line of the molten salt system.

22. The method of claim 21, further comprising
prior to the operating, opening a first isolation valve and a second isolation valve, the first isolation valve integrated with the upper channel and operable to block flow therethrough, the second isolation valve integrated with the lower channel and operable to block flow therethrough, and
wherein the operating comprises moving at least a portion of the coupon device through each of the first isolation valve and the second isolation valve.

23. The method of claim 22, further comprising maintaining a coupon portion of the coupon device in the flow line of the molten salt system and exposing the coupon portion to molten salt flowing therethrough.

24. The method of claim 23, further comprising second operating the actuation mechanism to move the coupon device from the sampling position to the upper channel such that the coupon device is fully within an inert environment of the upper channel.

25. The method of claim 24, further comprising
closing the first isolation valve and the second isolation valve, and
removably uncoupling the upper assembly from the lower assembly.

26. The method of claim 25, further comprising disposing the upper assembly in an inert environment while maintaining the coupon device within the inert environment of the upper channel.
